(19) United States
(12) Patent Application Publication
(10) Pub. No.: US 2021/0343441 A1
(43) Pub. Date: Nov. 4, 2021

(54) LASER DECONTAMINATION SYSTEM

(71) Applicant: KOREA INTITUTE OF MACHINERY & MATERIALS, Daejeon (KR)

(72) Inventors: Sang Hoon AHN, Daejeon (KR); Dong Sig SHIN, Daejeon (KR); Jiyeon CHOI, Daejeon (KR); Jiwhan NOH, Daejeon (KR); Hee-shin KANG, Daejeon (KR); Kyung Han KIM, Daejeon (KR); Hyon Kee SOHN, Daejeon (KR); Jaehoon LEE, Daejeon (KR); Jeng-O KIM, Daejeon (KR)

(21) Appl. No.: 17/281,024

(22) PCT Filed: Sep. 27, 2019
(86) PCT No.: PCT/KR2019/012658

§ 371 Date: Mar. 29, 2021

(30) Foreign Application Priority Data
Sep. 27, 2018 (KR) 10-2018-0115290

(51) Int. Cl. G21F 9/00; B23K 26/16; B23K 26/06; B23K 26/364; G01N 21/71; G21D 1/00

(52) U.S. Cl. CPC G21F 9/001; B23K 26/16; B23K 26/0652; G01N 2201/06113; B23K 26/364; G01N 21/718; G21D 1/003; B23K 26/0665

(57) ABSTRACT

A laser decontamination system according to an embodiment of the present invention includes: a laser generator generating a laser beam; an optical head inserted inside a pipe and focusing the laser beam on a contamination material inside the pipe for laser ablation; a first optical fiber connecting the laser generator and the optical head and transmitting the laser beam to the optical head; a spectroscope for analyzing a plasma spectrum generated in the pipe by the laser ablation; a second optical fiber connecting the spectroscope and the optical head and transmitting the plasma spectrum to the spectroscope; a dust collector for collecting a dust generated in the pipe by the laser ablation; a dust collection pipe connecting the dust collector and the inside of the pipe and transmitting the dust to the dust collector; and a blocking film positioned between the optical head and the pipe to block the dust.

### TECHNICAL FIELD

The present invention relates to a laser decontamination system. More particularly, the present invention relates to a laser decontamination system for decommissioning of a nuclear power plant.

### BACKGROUND ART

As a fossil energy is depleted worldwide, nuclear power generation is being used as a major energy source. A nuclear power plant using such nuclear power generation is expected to be decommissioned soon after its lifetime.

When decommissioning a nuclear reactor of the nuclear power plant, the nuclear reactor is highly radioactive, so if workers work in close proximity, there is a concern of radioactive exposure. Therefore, when decommissioning the nuclear reactor, a decontamination process is required.

However, the chemical decontamination method using a chemical material during the decontamination process generates a large amount of secondary liquid waste, and an additional treatment cost for the secondary waste is incurred. In addition, during the decontamination process, mechanical and arc cutting methods have difficulty in the decontamination of pipes or curved structures.

In addition, in order to proceed with the decontamination process inside the pipe, a contamination level of all radionuclides such as alpha rays, beta rays, and gamma rays, which are radioactive materials inside the pipe, must be grasped. However, if the decontamination device is moved inside the pipe, the decontamination device may be contaminated. In addition, such a decontamination device may measure only some nuclides of alpha rays, beta rays, and gamma rays, and it may be difficult to use the decontamination device when water or sludge is present in the pipe.

### DISCLOSURE

### Technical Problem

The present embodiment relates to a laser decontamination system capable of decontamination in a pipe or curved structure without generating secondary liquid waste.

### Technical Solution

A laser decontamination system according to an exemplary embodiment of the present invention includes: a laser generator generating a laser beam; an optical head inserted inside a pipe and focusing the laser beam on a contamination material inside the pipe for a laser ablation; a first optical fiber connecting the laser generator and the optical head and transmitting the laser beam to the optical head; a spectroscope for analyzing a plasma spectrum generated in the pipe by the laser ablation; a second optical fiber connecting the spectroscope and the optical head and transmitting the plasma spectrum to the spectroscope; a dust collector for collecting a dust generated in the pipe by the laser ablation; a dust collection pipe connecting the dust collector and the inside of the pipe and transmitting the dust to the dust collector; and a blocking film positioned between the optical head and the pipe to block the dust.

A plurality of spherical wheels installed on the outside of the optical head to be in contact with the inside of the pipe may be further included.

The dust collection pipe may penetrate the blocking film and collect the dust.

The optical head may include: a head main body; an optical system disposed inside the head main body and focusing the laser beam; and a rotation prism disposed inside the head main body and positioned on an optical path of the laser beam.

The optical head may include a supporting member for supporting the optical system; and a ball bearing disposed between the supporting member and the rotation prism and making the rotation prism rotatable.

The optical head may further include a transparent window installed on the head main body, and the transparent window is disposed corresponding to the rotation prism.

An analyzer connected to the spectroscope may be further included, and the analyzer may use the plasma spectrum to analyze nuclides of the contamination material inside the pipe in real time.

### Advantageous Effects

According to an embodiment, it is possible to selectively and easily remove the contamination material formed locally inside the pipe of a nuclear power plant by using the laser ablation. Therefore, it does not generate a separate secondary liquid waste.

In addition, the decontamination process may be performed by analyzing the plasma spectrum generated by the laser ablation through the spectroscope while measuring nuclides in real time.

### DESCRIPTION OF THE DRAWINGS

FIG. 1 is a schematic perspective view of a laser decontamination system according to an embodiment of the present invention.

FIG. 2 is a cross-sectional view showing a pipe inside of FIG. 1 in more detail.

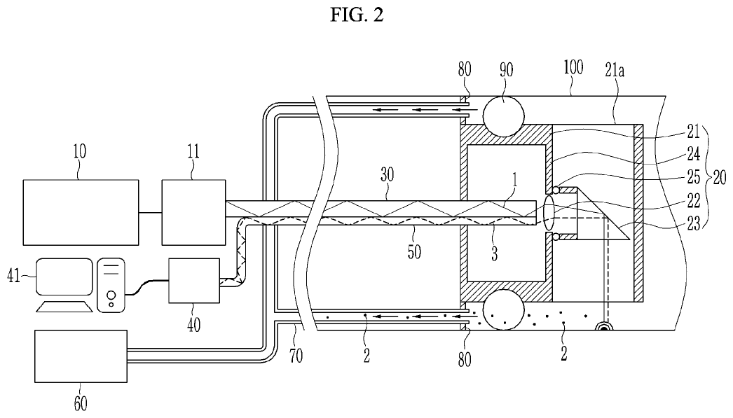

### MODE FOR INVENTION

The present disclosure will be described more fully hereinafter with reference to the accompanying drawings, in which embodiments of the invention are shown. As those skilled in the art would realize, the described embodiments may be modified in various different ways, all without departing from the spirit or scope of the present invention.

In order to clearly explain the present invention, portions that are not directly related to the present disclosure are omitted, and the same reference numerals are attached to the same or similar constituent elements throughout the entire specification.

In addition, the size and thickness of each configuration shown in the drawings are arbitrarily shown for better understanding and ease of description, but the present invention is not limited thereto.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it can be directly on the other element or intervening elements may also be present.

In addition, unless explicitly described to the contrary, the word “comprise”, and variations such as “comprises” or “comprising”, will be understood to imply the inclusion of stated elements but not the exclusion of any other elements. Further, in the specification, the word “˜on” means positioning on or below the object portion, but does not essentially mean positioning on the upper side of the object portion based on a gravity direction.

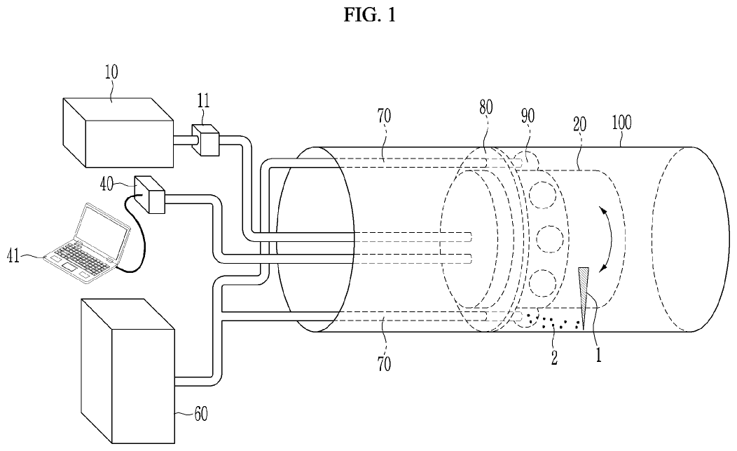

FIG. 1 is a schematic perspective view of a laser decontamination system according to an embodiment of the present invention.

As shown in FIG. 1, a laser decontamination system according to an embodiment include a laser generator 10, an optical head 20, a first optical fiber 30, a spectroscope 40, a second optical fiber 50, a dust collector 60, a dust collection pipe 70, and a blocking film 80.

The laser generator 10 may generate a laser beam 1 to remove a contamination material inside the pipe 100.

The optical head 20 is inserted into the pipe 100 and focuses a laser beam 1 on a contamination material inside the pipe 100 while moving inside the pipe 100 to perform laser ablation. This pipe 100 may be a pipe 100 of a primary system inside a nuclear power plant. Therefore, it is possible to remove a radioactive contamination material existing inside the pipe 100 by using the laser beam 1.

The optical head 20 may include a head main body 21 of a hexahedral shape, an optical system 22, a supporting member 24 for supporting the optical system 22, a rotation prism 23, and a ball bearing 25.

The head main body 21 may be formed of a metal material, and the optical system 22, the supporting member 24, the rotation prism 23, and the ball bearing 25 may be disposed inside the head main body 21.

In the present embodiment, the head main body 21 has the hexahedral shape, but it is not limited thereto, and may have various shapes as long as it may be inserted into the pipe 100.

The optical system 22 may focus the laser beam 1 and transmit it to the rotation prism 23.

The rotation prism 23 may be positioned inside the head main body 21 and be positioned on the optical path of the laser beam 1. Since one surface of the rotation prism 23 is coated, the laser beam 1 incident on the rotation prism 23 is reflected and irradiated to the inside of the pipe 100. This rotation prism 23 may irradiate the laser beam 1 to all areas inside the pipe 100 while rotating 360 degrees. Therefore, the laser beam 1 may remove the contamination material positioned in all areas inside the pipe 100.

The supporting member 24 may support the optical system 22 by being extended in a vertical direction from the head main body 21.

The ball bearing 25 may be installed between the supporting member 24 and the rotation prism 23. Therefore, the rotation prism 23 is easily rotatable.

A transparent window 21a may be installed in the head main body 21. The transparent window 21a may include glass or sapphire. The transparent window 21a may be disposed corresponding to the rotation prism 23. Therefore, the laser beam 1 passing through the inside of the head main body 21 may be irradiated into the pipe 100 through the transparent window 21a of the head main body 21. Also, by installing the transparent window 21a, it is possible to prevent sludge from penetrating into the optical system 22.

By using such an optical head 20, the laser beam 1 may be irradiated to the contamination material formed at a local position inside the pipe 100 having a curved surface.

The first optical fiber 30 connects the laser generator 10 and the optical head 20. Since the first optical fiber 30 has flexibility, even when the optical head 20 moves inside the pipe 100, the connection between the laser generator 10 and the optical head 20 can be stably maintained. The first optical fiber 30 may quickly transmit the laser beam 1 to the optical head 20 through total reflection.

A beam coupling unit 11 may be positioned between the laser generator 10 and the first optical fiber 30. The laser beam 1 oscillated from the laser generator 10 is incident on the first optical fiber 30 through the beam coupling unit 11. The beam coupling unit 11 may include a plurality of composite lenses. The beam coupling unit 11 may form a laser beam 10 having a smaller diameter than that of the first optical fiber 30 while maintaining a numerical aperture of 0.1 or less.

As such, the laser decontamination system according to an embodiment of the present invention may selectively and easily remove the contamination material formed locally inside the pipe 100 of the nuclear power plant by using the laser ablation. Therefore, it does not generate a separate secondary liquid waste.

The spectroscope 40 may analyze a plasma spectrum 3 generated in the pipe 100 in the decontamination process by the laser ablation.

The second optical fiber 50 connects the spectroscope 40 to the optical head 20. Since the second optical fiber 50 has flexibility, even when the optical head 20 moves inside the pipe 100, the connection between the spectroscope 40 and the optical head 20 may be stably maintained. This second optical fiber 50 may quickly transmit the plasma spectrum 3 to the spectroscope 40.

An analyzer 41 may be connected to the spectroscope 40. The analyzer 41 may analyze nuclides of the contamination material inside the pipe 100 in real time by laser-induced breakdown spectroscopy (LIBS) using a plasma spectrum.

As such, the laser decontamination system according to an embodiment of the present invention may perform the decontamination process while measuring the nuclides in real time by analyzing the plasma spectrum 3 generated by the laser ablation through the spectroscope 40.

The dust collector 60 may collect the dust 2 generated from the pipe 100 by the laser ablation. The dust collector 60 may include a suction pump (not shown) to collect the dust 2 inside the pipe 100. The dust collector 60 may include a filter (not shown) that may filter the dust 2.

The dust collection pipe 70 may connect the dust collector 60 and the inside of the pipe 100 and transfer the dust 2 to the dust collector 60. Since the dust 2 contains the radioactive contaminant material, exposure of the workers may be prevented by collecting the dust with the dust collector 60 through the dust collection pipe 70.

In addition, a blocking film 80 blocking the dust 2 may be positioned between the optical head 20 and the pipe 100. By installing the blocking film 80, the dust 2 may be prevented from spreading to the outside through the pipe 100. At this time, the dust collection pipe 70 may pass through the blocking film 80 to collect the dust 2. Therefore, the dust 2 may be collected by the dust collector 60 without being dispersed to the outside. This blocking film 80 may include a rubber material for more complete blocking.

A plurality of spherical wheels 90 may be installed outside the optical head 20. The spherical wheels 90 may be in contact with the inside of the pipe 100 and may stably move the optical head 20 to the inside of the pipe 100. The spherical wheels 90 may increase a flow velocity due to a negative pressure generated by the dust collector 60 by narrowing a gap between the optical head 20 and the inner wall of the pipe 100.

In the present embodiment, two spherical wheels are shown, but it is not limited thereto, in order to be easily moved inside the pipe 100, various numbers of the spherical wheels may be installed.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

Description of symbols

| | |
|---|---|
| 10: laser generator | 20: optical head |
| 30: first optical fiber | 40: spectroscope |
| 50: second optical fiber | 60: dust collector |
| 70: dust collection pipe | 80: blocking film |

1. A laser decontamination system comprising:
a laser generator generating a laser beam;
an optical head inserted inside a pipe and focusing the laser beam on a contamination material inside the pipe for laser ablation;
a first optical fiber connecting the laser generator and the optical head and transmitting the laser beam to the optical head;
a spectroscope for analyzing a plasma spectrum generated in the pipe by the laser ablation;
a second optical fiber connecting the spectroscope and the optical head and transmitting the plasma spectrum to the spectroscope;
a dust collector for collecting a dust generated in the pipe by the laser ablation;
a dust collection pipe connecting the dust collector and the inside of the pipe and transmitting the dust to the dust collector; and
a blocking film positioned between the optical head and the pipe to block the dust.

2. The laser decontamination system of claim 1, further comprising
a plurality of spherical wheels installed on the outside of the optical head to be in contact with the inside of the pipe.

3. The laser decontamination system of claim 1, wherein
the dust collection pipe penetrates the blocking film and collects the dust.

4. The laser decontamination system of claim 1, wherein
the optical head includes:
a head main body;
an optical system disposed inside the head main body and focusing the laser beam; and
a rotation prism disposed inside the head main body and positioned on an optical path of the laser beam.

5. The laser decontamination system of claim 4, wherein
the optical head includes:
a supporting member for supporting the optical system; and
a ball bearing disposed between the supporting member and the rotation prism and making the rotation prism rotatable.

6. The laser decontamination system of claim 2, wherein
the optical head further includes
a transparent window installed on the head main body, and
the transparent window is disposed corresponding to the rotation prism.

7. The laser decontamination system of claim 1, further comprising
an analyzer connected to the spectroscope, and
the analyzer uses the plasma spectrum to analyze nuclides of the contamination material inside the pipe in real time.
